(19) United States
(12) Patent Application Publication
(10) Pub. No.: US 2009/0131103 A1
(43) Pub. Date: May 21, 2009

(54) Method and System for Producing Digital Souvenirs

(75) Inventors: Charles Liu, Chapel Hill, NC (US); Daniel P. Homiller, Cary, NC (US)

Correspondence Address: COATS & BENNETT/SONY ERICSSON, 1400 CRESCENT GREEN, SUITE 300, CARY, NC, 27518, US

(73) Assignee: Sony Ericsson Mobile Communications AB, Lund (SE)

(21) Appl. No.: 11/940,348

(22) Filed: Nov. 15, 2007

(51) Int. Cl. H04M 1/00

(52) U.S. Cl. 455/556.1

(57) ABSTRACT

Methods and systems for producing digital souvenirs are disclosed. In an exemplary method, an order message is received from a requesting device via a short-range wireless link, such as a near-field communications (NFC) link. A first digital object included in the order message is combined with a stored digital object to obtain a customer object; in one or more embodiments the first digital object, stored digital object, and customer object each comprise a digital image. The resulting customer object is stored, and resource locator information is sent to the requesting device. The resource locator information comprises a network address for use in retrieving the stored customer object.

### BACKGROUND

The present invention relates generally to communications systems and more particularly relates to methods and apparatus for producing digital souvenirs based on a short-range wireless transaction between a portable device and a network-connected processing system.

Modern communication devices are increasingly likely to support a variety of applications in addition to a variety of communications modes. Mobile telephones, for example, commonly include video/still cameras and music players, and support e-mail, instant messaging, text messaging, picture messaging, online chat, and various other applications, as well as providing conventional telephone functionality.

Even when a camera, such as the camera integrated into a mobile phone, is readily available, travelers and tourists frequently encounter situations where taking a desired snapshot is difficult or impossible. For example, a popular site may be too crowded, or the weather might interfere with outdoor picture-taking. Photography may be forbidden in some situations, or a particular vantage point may be inaccessible.

Although many tourist venues provide postcards and other souvenirs, these souvenirs typically lack personalization. Facilitating the generation of personalized digital souvenirs will provide new business opportunities for tourist-related vending, as well as making sponsoring sites more appealing to visitors.

### SUMMARY

The present invention provides methods and systems for producing digital souvenirs. In an exemplary method, an order message is received from a requesting device via a short-range wireless link, such as a near-field communications (NFC) link. A first digital object included in the order message is combined with a stored digital object to obtain a customer object; in one or more embodiments the first digital object, stored digital object, and customer object each comprise a digital image. The resulting customer object is stored, and resource locator information is sent to the requesting device. The resource locator information comprises a network address for use in retrieving the stored customer object.

### BRIEF DESCRIPTION OF THE DRAWINGS

FIG. 1 illustrates a communications network including a system according to one or more embodiments of the present invention.

FIG. 2 is a flow diagram illustrating an exemplary method for producing digital souvenirs.

FIG. 3 illustrates a method for producing souvenir images according to an embodiment of the invention.

FIG. 4 is a block diagram illustrating functional components of an exemplary system for producing digital souvenirs according to several embodiments of the invention.

### DETAILED DESCRIPTION

While the invention is susceptible to various modifications and alternative forms, specific embodiments are shown by way of example in the drawings and will be described in detail below. It should be understood, however, that there is no intent to limit the invention to the particular forms described in detail. Those skilled in the art will recognize various alternatives to the illustrated embodiments falling within the scope of the claims.

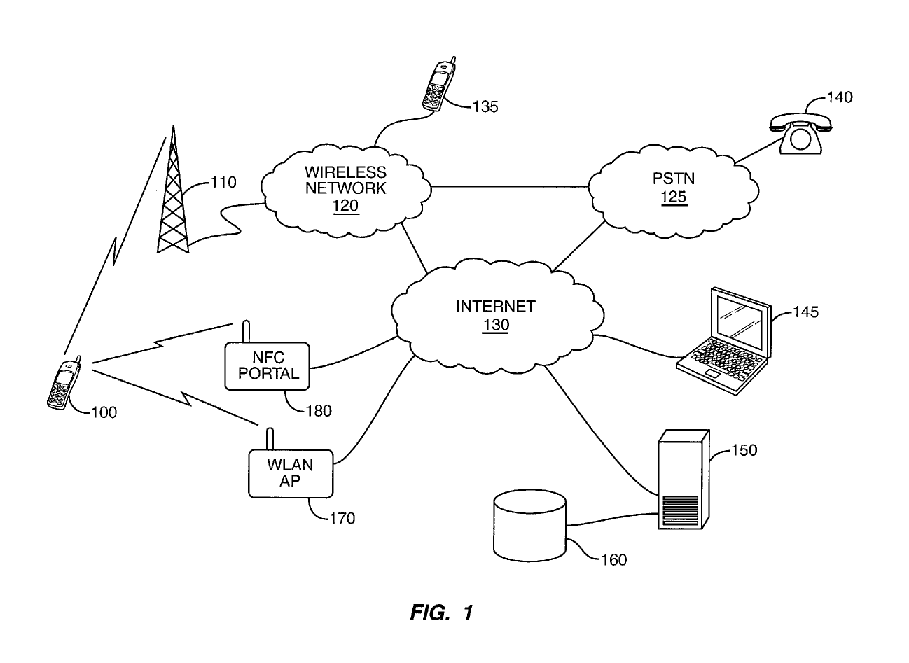

FIG. 1 illustrates a communications system in which the present invention may be employed. Communications device 100 communicates with other devices through base station 110, which is connected to wireless network 120. Wireless network 120 is in turn connected to the Public Switched Telephone Network (PSTN) 125 and the Internet 130. Wireless device 100 can thus communicate with various other devices, such as wireless device 135, conventional land-line telephone 140, or personal computer 145. In FIG. 1, wireless device 100 also has access to data server 150 via the Internet 130; data server 150 may be configured to provide access through Internet 130 to data stored in storage device 160. Storage device 160 may comprise one or more of a variety of data storage devices, such as disk drives connected to data server 150 or one or more other servers, a Redundant Array of Inexpensive Drives (RAID) system, or the like.

Communications device 100 may be a cordless telephone, cellular telephone, personal digital assistant (PDA), communicator, computer device, or the like, and may be compatible with any of a variety of communications standards, such as the Global System for Mobile Communications (GSM) or one or more of the standards promulgated by the 3rd-Generation Partnership Project (3GPP). Communications device 100 may include a digital camera, for still and video images, as well as a digital sound recorder and digital music player application. Communications device 100 may also support various data applications, such as e-mail, text messaging, picture messaging, instant messaging, video conferencing, web browsing, and the like.

Communications device 100 also includes a wireless local-area network (WLAN) transceiver configured for communication with WLAN access point 170. WLAN access point 170 is also connected to Internet 130, providing communications device 100 with alternative connectivity to Internet-based resources such as data server 150.

Finally, communications device 100 includes a near-field communications (NFC) device configured for communication with NFC portal 180. As those skilled in the art will readily appreciate, NFC is a short-range wireless communication technology enabling the exchange of data between devices over a very short distance, perhaps up to twenty centimeters. NFC technology has recently been introduced to mobile telephones, and is expected to support such applications as mobile ticketing, mobile payments, and other “e-commerce” transactions. NFC technology is widely viewed as complementary to other short-range wireless technologies such as Bluetooth and wireless LAN. Although limited in range, NFC data exchanges typically require less setup than other short-range wireless connections; a transaction is often completed by simply placing, or “swiping,” an NFC-equipped device near a compatible device. The limited range also provides a certain degree of inherent security, although conventional security mechanisms may be adapted for NFC just as they have been for other wireless communications links to provide additional transaction security.

Connected to Internet 130, NFC portal 180 has access to network-based applications and network-accessible data, such as might be provided by data server 150 and data storage 160. For instance, NFC portal 180 may be configured to conduct various e-commerce transactions with mobile device 100, communicating with network-based financial applications and databases as necessary to support the transactions. In particular, NFC portal 180 may be configured as a point-of-sale terminal for providing digital souvenirs in accordance with one or more embodiments of the present invention. For example, NFC portal 180 might be deployed at a tourist site and configured for vending digital images related to the site.

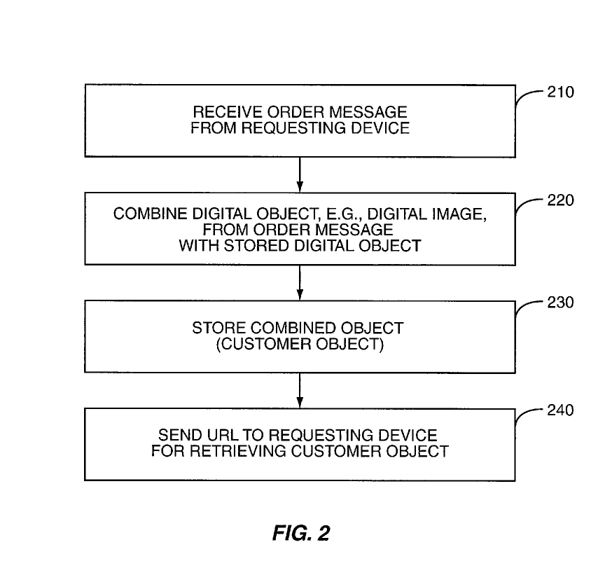

FIG. 2 illustrates a general method for producing digital souvenirs, such as might be implemented with the system of FIG. 1, and, in particular, with NFC portal 180. However, after viewing the drawings and reading the description, those skilled in the art will appreciate the applicability of the method illustrated in FIG. 2 to various other devices and/or network configurations.

At block 210, an order message is received from a requesting device. Referring to FIG. 1, for example, the order message may be transmitted by mobile device 100 to NFC portal 180 over a NFC link. Broadly speaking, this order message indicates that the requesting device's user wishes to have a digital souvenir produced. The order message (which may comprise several separately transmitted parts, depending upon the particular communications protocol employed) may include identifying information (identifying device 100, for example, or its user) as well as one or more parameters indicating which of several souvenir types or options the requesting user would like to receive. In some embodiments of the invention, the device receiving the order message, e.g., NFC portal 180, may comprise a user interface configured to allow a user to input product selections or options, in which case the order message may simply comprise identifying information and/or payment information. In other embodiments, the requesting device may be configured to receive selection information for the offered products, whether over the NFC link, via WLAN access point 170, or via the wireless network 120 via base station 110. In these embodiments, the user may make his selections at the requesting device, transmitting parameters corresponding to those selections along with the order message.

In any event, the order message received at block 210 also comprises a digital object. In several embodiments, the digital object comprises a digital image stored on the requesting device (e.g., mobile device 100). In others, the digital object may comprise a digital video clip, a sound file, or some combination. At block 220, the digital object is combined with a stored digital object to create a customer object. For example, the stored digital object may in some embodiments comprise a background image, which is combined with a digital image received in the order message to form a souvenir image. The background image might comprise, for example, a high-quality photographic image of a tourist attraction. The submitted digital image, on the other hand, might comprise a personal photo of the requesting device's user and/or her friends or family members. The resulting customer object in this example is a personalized image of the tourist attraction.

In other embodiments, the customer-supplied digital object may comprise an audio clip, which may be combined with a stored digital image or video clip to create a personalized multimedia postcard. In yet other embodiments, a customer-supplied video clip may be digitally inserted into a stored video file to create a personalized souvenir.

Those skilled in the art will appreciate that the combining of the submitted digital object with the stored digital object may be performed automatically in some embodiments. Other implementations may require some human intervention to achieve the highest quality combinations. Thus, the combining of the objects may be performed entirely at NFC portal 180, for example, or the order message may be sent elsewhere by NFC portal 180 for later processing, such as to applications server 150.

The stored digital object that is combined with the submitted digital object may be retrieved from memory included in NFC portal 180, or from a storage element accessible through Internet 130, such as data storage 160. In some embodiments, a menu presenting “thumbnail” images or other representations of the stored digital object may be provided to the requesting device user via a display at NFC portal 180, or via the user interface of mobile device 100. In these embodiments, the user may select one (or more) of the stored digital images for combining with his submitted image.

At block 230, the customer object, i.e., the combined digital object, is stored for later retrieval by the requesting device user. The customer object is typically stored at a network-accessible memory device, such as the data storage 160 illustrated in FIG. 1. The storage for the customer object may or may not be co-located with either the point-of-sale terminal (e.g., NFC portal 180) or a supporting application server 150.

At block 240, resource locator information is sent to the requesting device, the resource locator information providing an electronic network address for retrieving the stored customer object. This resource locator information may comprise a Uniform Resource Locator (URL), thus providing a convenient mechanism for accessing the stored customer object with a browser-equipped device. Typically, the resource locator information is sent to the requesting device via the same communications link over which the order message was received. Thus, NFC portal 180 may be configured in some embodiments to directly respond to an order message received from mobile device 100 over the NFC link. In other embodiments the resource locator information may be sent by one or more alternative means, including by short message service (SMS), e-mail, or the like.

Although the customer object may in some cases be sent to the requesting device upon completion, sending only the resource locator information may be preferred in many situations. For example, a high-quality digital image may be too large to conveniently transfer over some short-range wireless links (and almost certainly too large for an NFC transfer). Providing a resource locator permits the requesting user to retrieve the customer object at his leisure, using a retrieval method of her choice. Furthermore, some embodiments of the invention may include processing performed by humans (albeit computer-aided); in these embodiments, the customer object may not be available until minutes or hours after the order is placed.

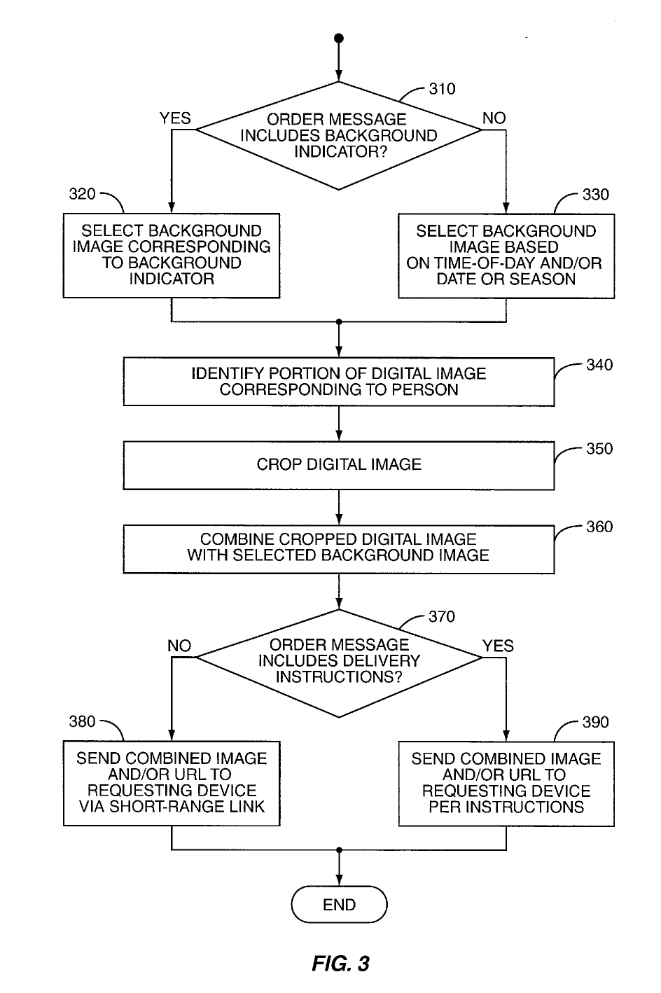

Those skilled in the art will appreciate that the method of FIG. 2 may be extended in a number of ways. In FIG. 3, a number of additional features, such as might be implemented in a system providing souvenir images according to the present invention, are illustrated.

As mentioned above, the order message received from the requesting device may include a parameter indicating one or more of several available background images. A point-of-sale terminal, for example, may present several options for the background image. These options may include different views of a particular tourist attraction, for instance. Accordingly, an order message received from the requesting device is checked at block 310 to determine whether it includes a background indicator parameter. If it does, the background indicator is used to select the corresponding background image from the available images, as illustrated at block 320.

In some embodiments, the absence of a background indicator in the order message will result in the selection of a default background image. However, this default background image may vary depending on one or more of the time of day, the season, or the date. Thus, block 330 illustrates the selection of a background image from several available images based on one or more of these temporal parameters. Accordingly, an autumn view of an outdoor attraction might be selected, in some embodiments, if the order message is presented in October, while a snow-covered scene may be used for February transactions. Similarly, a late afternoon request may trigger the selection of a particular site illuminated with afternoon sun, or of a sunset view.

Some embodiments of a system for providing souvenir images may include considerable processing of the submitted and background images. At block 340, for example, a digital image submitted with the order message is examined to identify a portion or portions of the digital image that correspond to one or more people in the image. At block 350, the digital image is cropped to remove features other than the identified person, and the cropped digital image is combined with the selected background image at 360. Typically, the cropped digital image is superimposed on the background image. In some embodiments, digital rights management (DRM) information and/or digital watermark data may be added to the combined image.

Those skilled in the art will appreciate that the described processing, including identifying people in a digital image, cropping the digital image, and combining the image with a background image, may be automatically performed using computer software. For example, facial recognition software may be adapted to identify a person in a digital image, and to provide parameters for cropping the image accordingly. However, better results may be achieved in some cases with the use of human-assisted processing. Thus, in some embodiments of the invention, the submitted image (and optionally the background image) may be transmitted to an application server, such as application server, and made available to a workstation, such as personal computer 145, for human input. The submitted image may be presented to a human operator who may input, for example, cropping information to be used by an automated cropping routine. The human operator may, for instance, trace the outline of one or more people pictured in the digital image; the traced outline may be used by a software-based routine to automatically crop the digital image before superimposing the cropped image upon the background image. In some cases, the human operator may provide input for scaling the cropped image, so that pictured persons appear at an appropriate scale relative to the background image.

Whether the processing of steps 340, 350, and 360 is performed automatically or with human assistance, resource locator information indicating where the completed customer image is stored is sent to the requester. As mentioned earlier, some embodiments of the invention may employ different means for sending the resource locator information to the requesting device than was used to place the order. Accordingly, the order message may be examined, as illustrated at block 370, to determine whether it includes delivery instructions. If not, a URL (and, in some embodiments, the combined image) are sent to the requesting device via a default means, such as the short-range link over which the order was received. This is illustrated at block 380. If the order message specifies delivery instructions, on the other hand, the URL, and in some cases, the combined image, may be sent to the requester according to the delivery instructions, as shown at block 390. In some embodiments, for example, the delivery instructions may specify an e-mail address, while in others the delivery instructions may specify a phone number for sending SMS messages. In some embodiments, a system may automatically send the completed image to an e-mail address, when specified, while sending only the resource locator information if an SMS address is indicated. In others, the order message may include one or more parameters indicating whether a completed image should be automatically sent, or just the resource locator information.

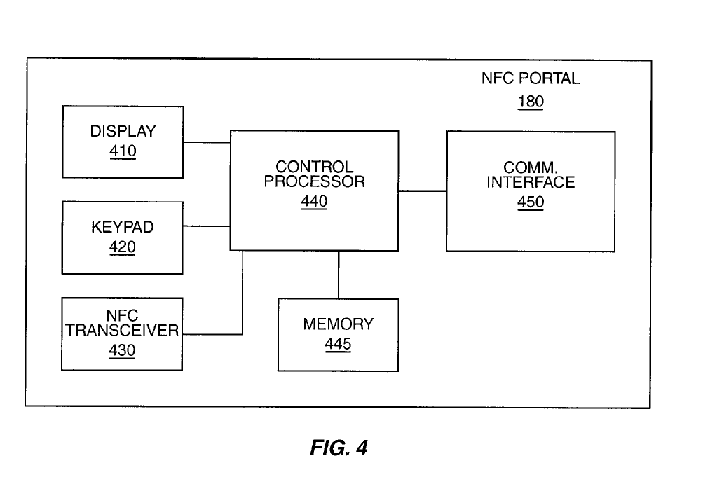

FIG. 4 illustrates functional components of an NFC portal 180, which may be configured to carry out one or more of the methods described above. NFC portal 180 comprises a display 410 and keypad 420—these user interface devices allow a user to view and select product offerings, input user identification information or financial information, or the like. NFC portal 180 also includes NFC transceiver 430, which is configured to communicate with portable devices, such as mobile device 100, configured with compatible NFC technology. NFC portal 180 further comprises control processor 440 which controls NFC transceiver 430 and display 410, receives user input from keypad 420, and communicates with other network-connected devices via communications interface 450. Communications interface 450 provides an interface to Internet 130, and may comprise a wired interface (such as an Ethernet connection), a wireless interface (such as a WLAN or wide-area network transceiver). Control processor 445 is further connected to memory 445, which may store program code, operating data, and, in some embodiments, one or more stored digital objects.

In one or more embodiments, control processor 430 is configured to receive an order message from a requesting device via the NFC transceiver 430, the order message comprising at least a first digital object. In some embodiments, the control processor 430 is configured to combine the first digital object with a stored digital object to obtain a customer object. The stored digital object may be retrieved from local memory 445 or, in some embodiments, from a network-accessible storage element, such as data storage 160 pictured in FIG. 1, via communications interface 450.

After the customer object is produced, control processor 430 stores the customer object in a network-accessible storage unit. In some embodiments, the customer object may be stored in local memory 445, in which case control processor 430 may be further configured to provide a server interface to the Internet 130, so that requesting devices can retrieve the stored customer objects. In other embodiments, however, control processor 430 is configured to store customer objects at one or more remote locations, such as by sending the customer object to application server 150 (via communications interface 450) for storage at storage device 160.

Finally, control processor 430 is configured to send resource locator information to the requesting device, the resource locator information identifying a network address from which the stored customer object may be retrieved. In some embodiments, the resource locator information, which may comprise a URL, may be sent to the requesting device via the NFC transceiver 430. However, the URL may also be sent to the requesting device via an alternate communications link, such as by e-mail message sent via communications interface 450 and Internet 130.

Those skilled in the art will appreciate that the operations of control processor 430 may be implemented using computer program instructions and/or hardware operations. These computer program instructions may be stored in memory 445, or in another memory device. These computer program instructions may be provided to a microprocessor or other programmable data processing apparatus to produce a machine, such that the instructions, which execute via the processor of the computer or other programmable data processing apparatus, create means for implementing the functions described herein and illustrated in the accompanying block diagrams and flow diagrams.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the functions described herein.

Several of the processing operations described herein, including the operations of the control processor 430 depicted in FIG. 4, may be implemented together on a single processor or computer, or each may be implemented on separate processors or computers. In particular, although the discussion of FIG. 4 above describes a system in which the combining of digital objects is performed at the point-of-sale terminal, those skilled in the art will appreciate that the combining and storing operations may be carried out by a separate computer, such as the application server 150 pictured in FIG. 1.

Thus, in several embodiments, a system for producing digital souvenirs may comprise a point-of-sale terminal, equipped with an NFC transceiver or other short-range wireless technology and configured to receive an order message from a requesting device. This point-of-sale terminal may then send the order message, including the customer-supplied digital object to a remote computer, such as application server 150, for subsequent processing. In such a system, the resource locator information may be sent to the requesting device by the point-of-sale terminal (e.g., via the short-range wireless link) or by the application server 150, perhaps by e-mail.

In other embodiments, a point-of-sale terminal may be separate from, but connected to, a short-range wireless transceiver, such as the WLAN access point 170 of FIG. 1. In these embodiments, the order message may be received by the short-range wireless transceiver and forwarded to the point-of-sale terminal for further processing.

The present invention may, of course, be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A method for producing digital souvenirs, comprising:
receiving an order message from a requesting device via a short-range wireless link, the order message comprising a first digital image;
combining the first digital image with a stored digital image to obtain a souvenir image;
storing the souvenir image;
sending resource locator information to the requesting device, the resource locator information comprising a network address for use in retrieving the stored souvenir image.

2. The method of claim 1, wherein the stored digital image comprises a background image.

3. The method of claim 2, wherein the order message further comprises a background indicator, and wherein the method further comprises selecting the background image from a plurality of available background images based on the background indicator.

4. The method of claim 2, further comprising selecting the background image from a plurality of available background images based on one or more of a current date, a time of day, or a season.

5. The method of claim 2, wherein combining the first digital image with a stored digital image comprises cropping the first digital image and superimposing the cropped first digital image on the background image to obtain the souvenir image.

6. The method of claim 5, wherein cropping the first digital image comprises identifying a portion of the first digital image corresponding to all or part of at least one person and cropping the first digital image to obtain a cropped first digital image including the identified portion.

7. The method of claim 1, wherein the short-range wireless link comprises a near-field communications link.

8. The method of claim 1, further comprising sending the souvenir image to the requesting device via the short-range wireless link.

9. The method of claim 1, wherein the order message further comprises a communications address, and wherein the method further comprises sending the souvenir image to the communications address.

10. The method of claim 1, wherein combining the first digital image with a stored digital image to obtain a souvenir image comprises adding digital watermark information to the combined first digital image and stored digital image to obtain the souvenir image.

11. A system for producing digital souvenirs, comprising
a short-range wireless transceiver configured to send and receive messages from a requesting device, and
one or more control processors configured to:
receive an order message from the requesting device via the short-range wireless transceiver, the order message comprising a first digital image;
combine the first digital image with a stored digital image to obtain a souvenir image;
store the souvenir image in a network-accessible storage unit; and
send resource locator information to the requesting device, the resource locator information comprising a network address for retrieving the stored souvenir image.

12. The system of claim 11, wherein the stored digital image comprises a background image.

13. The system of claim 12, wherein the order message further comprises a background indicator, and wherein the one or more control processors are further configured to select the background image from a plurality of available background images based on the background indicator.

14. The system of claim 13, wherein the one or more control processors are further configured to select the background image from a plurality of available background images based on one or more of a current date, a time of day, or a season.

15. The system of claim 11, wherein the one or more control processors are configured to combine the first digital image with the background image by cropping the first digital image and superimposing the cropped first digital image on the background image to obtain the souvenir image.

16. The system of claim 15, wherein the one or more control processors are configured to crop the first digital image by identifying a portion of the first digital image corresponding to all or part of at least one person and cropping the first digital image to obtain a cropped first digital image including the identified portion.

17. The system of claim 11, wherein the short-range wireless transceiver comprises a near-field communications transceiver.

18. The system of claim 11, wherein the one or more control processors are further configured to send the souvenir image to the requesting device using the short-range wireless transceiver.

19. The system of claim 11, further comprising a network interface, wherein the order message further comprises a communications address and wherein the one or more control processors are further configured to send the souvenir image to the communications address using the network interface.

20. The system of claim 11, wherein the one or more control processors are further configured to add digital watermark information to the combined first digital image and stored digital image to obtain the souvenir image.
